(19) United States
(12) Patent Application Publication
(10) Pub. No.: US 2013/0081300 A1
(43) Pub. Date: Apr. 4, 2013

(54) VACUUM CYCLING DRYING

(71) Applicant: Donald J. Gray, Warwick, RI (US)

(72) Inventor: Donald J. Gray, Warwick, RI (US)

(21) Appl. No.: 13/624,545

(22) Filed: Sep. 21, 2012

Related U.S. Application Data
(60) Provisional application No. 61/541,995, filed on Sep. 30, 2011.

(51) Int. Cl. F26B 5/04

(52) U.S. Cl. 34/412

(57) ABSTRACT

The invention generally relates to methods and systems of drying objects containing interior surfaces. In particular, the present invention provides a method which alternates vacuum and pressure with heated gases to enhance interior drying of parts. More particularly, the method cycles the chamber through a vacuum phase that rapidly removes vapor from the object both convectively and through boiling followed by a pressure phase that delivers heat and fresh gases to difficult regions of the objects to be dried.

### CROSS REFERENCE TO RELATED APPLICATION

This application is related to and claims priority from earlier filed provisional patent application Ser. No. 61/541,995, filed Sep. 30, 2011 and incorporated herein by reference.

### BACKGROUND OF THE INVENTION

The invention generally relates to methods and systems of drying objects containing interior surfaces. In particular, the present invention provides a method which alternates vacuum and pressure with heated gases to enhance interior drying of parts. More particularly, the method cycles the chamber through a vacuum phase that rapidly removes vapor from the object both convectively and through boiling followed by a pressure phase that delivers heat and fresh gases to difficult regions of the objects to be dried

Two types of drying processes used today are vacuum drying and forced convection drying. In the former method, vacuum is applied to a chamber containing object to be dried. As the pressure drops in the chamber, non-condensable gases are removed along with vapor from the liquid on the object and the liquid on the object begins to evaporate in order to maintain the liquid vapor pressure within the chamber. When all of the non-condensable gases are removed, the pressure in the chamber reaches the vapor pressure of the liquid on the object. At this point the liquid is boiling off the part and the removal rate can be rapid. The major problem with the process is that the object will cool as the boiling continues. The heat of vaporization required to boil the liquid obtains the heat from the specific heat of the object and liquid unless some form of energy is added to the chamber. As the object and liquid cools, the vapor pressure in the chamber decreases and the rate of vacuum removal of vapor drops dramatically. A pressure is often reached where the pump can no longer pull vacuum and the drying process essentially ceases.

Forced convection drying is usually operated at constant pressure, generally at or near atmospheric pressure. The process is therefore evaporative since the chamber pressure is always greater than the vapor pressure of the liquid on the object. Generally high temperatures are employed to heat the liquid and object thus increasing the vapor pressure of the liquid so as to enhance the diffusion process near the object needed to evaporate the liquid. The higher vapor pressure leads to a greater vapor concentration near the object and the higher temperature provides for greater molecular diffusion through the fluid boundary layer near the object. The problem with forced convection heating is that there are often stagnant locations within the object that sees little if any bulk hot gas. The heating process in these areas rely mostly on conduction through the solid object and the evaporative processes requires diffusion through much larger paths than encountered by surface liquid both processes can be very slow.

Therefore, there is a need in the prior art to overcomes the limitations of both the processes above.

### BRIEF SUMMARY OF THE INVENTION

The present invention is directed to a controlled environment processing chamber or chambers into which solvents, water and/or gases used for processing a material can be introduced. The process includes a means of applying a negative gauge pressure to the chamber to remove air or other non-condensable gases. Means are provide for introducing a heated gas. A first step introduces heated gas into the chamber containing the object to be dried. A second step stops the heated gas flow into the chamber and applies a vacuum to remove previously introduced gases. The vacuum is applied until pressures reach levels at or near the vapor pressure of the fluid being dried from the object. A third step stops the removal of gases and reintroduces heated gases to the chamber a second time. The cycling of vacuum and introduction of heated gas is repeated until the part is dried to the desired level.

The invention includes a chamber that can be enclosed and is capable of withstanding positive or negative pressures or both. The invention also includes a vacuum pump and a heat gas delivery system to the chamber. The invention steps are as follows:

a) The object to be dried is placed in the chamber;

b) The chamber is sealed to enclose the chamber;

c) Heated gas is introduced to the chamber from the heated gas delivery system;

d) The gas is exhausted from the chamber until the object is heated to a desired temperature;

e) The heated gas and exhaust is then stopped and a vacuum pump pulls on the chamber;

f) The vacuum pump reduces the pressure in the chamber while evaporating the liquid from the object; and

g) Upon reaching a low pressure step c through f are repeated again.

The above invention provides for an effective environment for drying porous or high aspect ratio surface channels or vias.

In the preferred embodiment, the cycling described above is fairly rapid. Within a porous media, when applying the vacuum, the gas is removed from the pores carrying with it the water vapor that saturated the gas within the pore. When heated gas is introduced to the chamber, the gas refills the pores with fresh unsaturated hotter gas than what was previously removed. The gas can now evaporate more water since the gas is unsaturated the gas cools and the gas approaches a saturated state rapidly. Applying vacuum to the chamber now removes this near saturated gas increasing the rate of drying significantly over conventional vacuum drying where water vapor in the pores have little to no driving force for transport to the bulk gas phase in the chamber. Introducing heated gas again starts another cycle.

The high efficiency of the drying is due to the cycling of pressure and vacuum as described above. In the preferred embodiment, the vacuum and pressure steps are therefore less than a minute. In the preferred embodiment the vacuum and pressure steps are less than 15 seconds. Since the vapor removal from the pores is forced convective transfer, vacuum pressure levels do not need to reach the vapor pressure of the liquid. Vacuum steps of less than a second have shown to be effective.

Some examples of objects that can effectively be dried are filters, semi-conductor vias, flip chip and microelectronic channels, medical lumens, needles, trocars, cannulas, endoscopes and medical implants.

It can therefore be seen that the present invention provides a unique method for drying an object in an enclosed system that is more rapid than either vacuum or forced convection drying methods. The system can therefore dry more efficiently increasing product throughput and conserving energy.

The above-noted method can be effectively be used to remove volatile liquid residue from a solid's internal and external surface. The effectiveness is site insensitive since a pressure reduction or heat transfer is uniform throughout the system and thus the pressure or heat inside channels and pores is equal to the surface conditions.

Another aspect of this invention is to decrease the normal time required to dry an object using conventional convective or vacuum drying techniques.

Another aspect of this invention is to dry an object uniformly both internally and externally.

Another aspect of this invention is to minimize energy to dry an object by reducing internal part's heating times and increasing the saturation level of drying gases.

Another aspect of this invention is to minimize the amount of gas required to dry and object.

Another aspect of this invention is to dry an object in an enclosed environment in order to maintain cleanliness and corrosion during drying.

Other objects, features and advantages of the invention shall become apparent as the description thereof proceeds when considered in connection with the accompanying illustrative drawings.

### BRIEF DESCRIPTION OF THE DRAWINGS

These and other features, aspects, and advantages of the present invention will become better understood with reference to the following description, appended claims, and accompanying drawings where:

FIG. 1 is a schematic illustration of the present invention; and

FIG. 2 is a schematic illustration of another embodiment of the present invention.

### DETAILED DESCRIPTION OF THE PREFERRED EMBODIMENTS

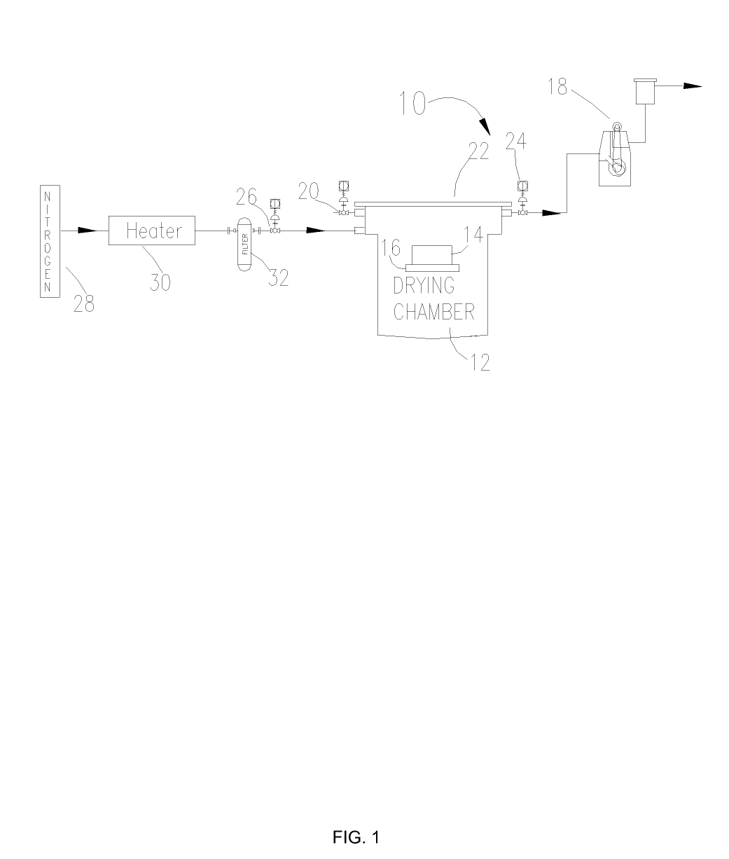

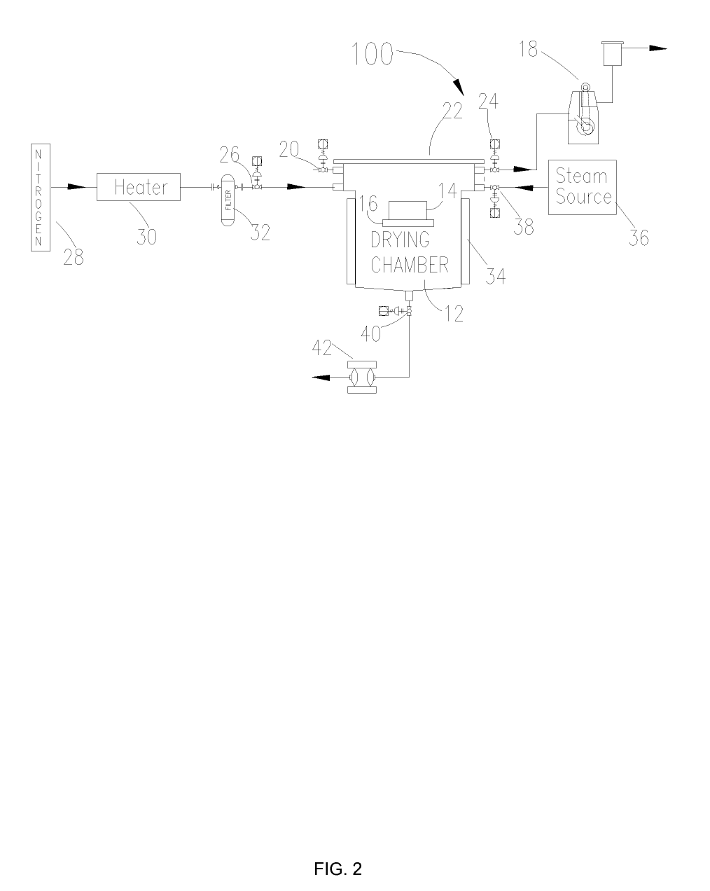

Referring now to the drawings, the method and system of the present invention is generally illustrated in FIGS. 1 and 2. In one embodiment, the present invention requires a vacuum pump, a heated gas source and a processing chamber in fluid communication with each other. A depiction of the process is shown in FIG. 1. In FIG. 1, the drying method 10 includes a processing chamber 12 having an object 14 requiring the drying of volatile residue placed upon a support 16 fixedly mounted within the processing chamber 12. A valve 20, in fluid communication with the atmosphere and the processing chamber 12, is provided for selectively introducing air into the processing chamber 12.

The object 18 is placed into the processing chamber 12 on the support 16 through an opening created by removing a lid 22. After receiving the object 18, the lid 22 is secured to the processing chamber 12 wherein the processing chamber 12 is sealed. Valve 24 is opened and the air handling vacuum pump 18 is used to remove air from the processing chamber 12.

Upon the removal of the air from chamber 12, valve 26 is opened and nitrogen from nitrogen source 28 is introduced to the chamber 12. Other gases such as ambient air, clean dry air, carbon dioxide or other non-condensable gases can also be used for drying. In the preferred embodiment, the nitrogen is previously heated with a gas heater 30 and filtered with filter 32. Drying can also be accomplished with simply dry nitrogen or by heating the chamber 12 walls. Because of a reduced atmosphere in the chamber, the nitrogen entering the chamber can freely enter any and all internal volumes of object 14 thus heating the object 14 in a more uniform method than conventional forced convection drying methods. The nitrogen can now evaporate fluids from the internal surfaces of the object 14 rather than depend upon the diffusion of the fluid vapor to the surface of object 14.

After allowing time for the nitrogen to heat the object 14, valve 26 is closed and valve 24 is opened to allow chamber 12 connection to vacuum pump 18. Vacuum pump 18 now removes the nitrogen from chamber 12 down to levels near the vapor pressure of the fluid being dried. Generally vacuum pressures in the range of 50 to 650 mmHg are used. As the nitrogen is being removed from the chamber 12, nitrogen on the internal volume of the object 14 is also being removed and the internal evaporated fluids are now transported convectively to the bulk chamber 14 volume and out of the chamber through vacuum pump 18. This method of delivering the drying gas to the internal surfaces being dried and subsequently removing the gases from the internal volume produces a much faster means of both heating and vapor removal when compared to traditional convection drying that results in a lower internal surface temperature and depends upon a slow diffusion process to remove evaporated vapor from the internal surfaces of object 14.

After evacuating the chamber 12, valve 24 is closed and valve 26 is opened to reintroduce heated nitrogen to the chamber. The cycling process of vacuum followed by pressurizing the chamber 14 with heated nitrogen is repeated until desired dryness is attained.

For a faster drying process, FIG. 2 shows some process additions that can be used to enhance the drying process. Prior to introducing nitrogen to the Chamber 12, steam can be introduced to chamber 12 from steam source 36 by opening valve 38. Steam would condense on the object 14 and the chamber walls preheating the object 14 and chamber 12. The condensing steam would be removed from the chamber by opening valve 42 and pumping the condensate through pump 42. Upon preheating the object 14 and chamber 12, valves 36 and 42 would be closed and pump 42 turned off. Vacuum would then be applied using vacuum pump 18 and the cycling of vacuum-pressure described above would be performed. Solvent vapors may also be used rather than steam. In addition, chamber 12 could be heated using heater 34. The heater 34 could be an electric pad or a jacket heated with steam or circulated heating fluid.

The above examples of the present invention has been described for purposes of illustration and are not intended to be exhaustive or limited to the steps described or vapors and gasses used in the descriptions. It will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of drying an object in an enclosed system, said system including a drying chamber, said method comprising the steps of:
placing the object within the chamber;
isolating the chamber;
reducing the pressure to evaporate fluid from an object's surface;
introducing a heated gas to said chamber to increase the pressure to introduce heated unsaturated gas to the object's surfaces;
reducing the chamber pressure a second time to remove saturated gas from near the object's surface; and
repeating the decrease and increase in pressure in a cyclical manner until the object is fully dried.

2. The method of claim 1 wherein said step of introducing a heated gas to said chamber to increase the pressure includes pressures up to 10 atmospheres.

3. The method of claim 1 wherein said step of reducing the chamber pressure a second time includes pressures between 10 mmHg and 1 atmosphere.

4. The method of claim 1 wherein said step of repeating the decrease and increase in pressure in a cyclical manner includes cycle times of 1 minute or less.

5. The method of claim 1 wherein said step of repeating the decrease and increase in pressure in a cyclical manner includes cycle times of 5 seconds or less.

6. The method of claim 1 wherein said step of introducing a heated gas to said chamber to increase the pressure includes preheating the said object and chamber with steam or solvent vapor.

7. The method of claim 1 wherein said step of introducing a heated gas to said chamber to increase the pressure to introduce heated unsaturated gas to the object's surfaces includes heating the said chamber.
